(19) United States
(12) Patent Application Publication
(10) Pub. No.: US 2011/0047965 A1
(43) Pub. Date: Mar. 3, 2011

(54) USE OF A LUBRICANT IN AN INTERNAL COMBUSTION ENGINE

(76) Inventors: Howard Richard Hayes, Chester Cheshire (GB); Dominique Jean Paul Pithoud, Petit Couronne (FR); David John Wedlock, Chester Cheshire (GB); Yanyun Wu, Chester Cheshire (GB)

(21) Appl. No.: 12/675,149

(22) PCT Filed: Aug. 29, 2008
(86) PCT No.: PCT/EP08/61363

§ 371 Date: Nov. 12, 2010

(30) Foreign Application Priority Data
Aug. 31, 2007 (EP) 07115414.0

(51) Int. Cl. F02B 27/04

(52) U.S. Cl. 60/273

(57) ABSTRACT

The present invention relates to the use of a lubricant in a diesel engine equipped with a regenerable diesel particulate trap, wherein the lubricant comprises a base oil component having a paraffin content of greater than 80 wt % paraffins, a saturates content of greater than 98 wt %, and comprising a series of iso-paraffins having n, n+1, n+2, n+3 and n+4 carbon atoms, wherein n is between 15 and 40, and to a process for operating a diesel engine equipped with a diesel particulate trap, comprising lubricating the diesel engine with the lubricant.

### FIELD OF INVENTION

The present invention relates to the use of a lubricant in a combustion engine. More specifically, the invention relates to a lubricant and fuel package for use in an internal combustion compression ignition engine equipped with a particulate trap.

### BACKGROUND OF THE INVENTION

In recent decades, use of internal combustion engines, in particular compression ignition engines for transportation and other means of energy generation has become more and more widespread. Compression ignition engines, which will be referred to further as “Diesel engines”, feature among the main type of engines employed for passenger cars in Europe, and globally for heavy duty applications, as well as for stationary power generation as a result of their high efficiency.

A Diesel engine is an internal combustion engine; more specifically, it is a compression ignition engine, in which the fuel/air mixture is ignited by being compressed until it ignites due to the temperature increase due to compression, rather than by a separate source of ignition, such as a spark plug, as is the case of gasoline engines.

The growing spread of Diesel engines has resulted in increased regulatory pressure with respect to engine emissions; more specifically with respect to exhaust gases and particulate matter in the exhaust gas stream.

It is desirable to reduce these emissions either as a whole or individually. Whilst some of the emissions have their origin in the fuel which is combusted in the engine, the lubricating oil which is used to lubricate the engine can also impact on the emissions, for example by direct emission of combustion products of the oil or by affecting the trap performance.

A variety of strategies for controlling and reducing in particular particulate matter emissions from Diesel engines have been reported in recent years. These include engine management, more specifically injection and combustion processes, as disclosed for instance in U.S. Pat. No. 6,651,614. Highly effective are Diesel particulate traps (DPTs) as disclosed for instance EP-A-1108862 and EP-A-1251248. Such devices are used on light and heavy duty diesel engines to ensure particulates emission compliance with for example Euro 4 standards, further improved by additives or selected fuels, such as the use of low sulphur fuels in combination with an engine oil having a low sulphur content to reduce the number of nucleation mode particles emitted from an engine further using a catalysed particulate trap as disclosed in WO-A-2004046283.

Diesel particulate traps usually operate by trapping particulate matter from the exhaust emissions of the engine. The mainly hydrocarbon derived organic particulate material will eventually cause DPT blocking and excessive pressure built-up.

This is addressed by subjecting the trap to very high temperature once the particulate trap has become saturated, by injecting for instance a certain amount of diesel fuel into the DPT to burn off the organic particulate matter. The regeneration of the Diesel particulate traps increases the fuel consumption and NOx production through the increased temperature in regeneration mode.

Hence, there is a need for a reduction of the regeneration frequency of diesel particulate matter traps.

It has now surprisingly been found by applicants that by using a specific lubricant, the regeneration frequency of the particulate trap can be significantly reduced, resulting in a reduction in NOx emission as well as a reduction in fuel consumption.

### SUMMARY OF THE INVENTION

Accordingly, the present invention relates to the use of a lubricant in a diesel engine equipped with a regenerable diesel particulate trap, wherein the lubricant comprises a base oil component having a paraffin content of greater than 80 wt % paraffins, a saturates content of greater than 98 wt %, and comprising a series of iso-paraffins having n, n+1, n+2, n+3 and n+4 carbon atoms, wherein n is between 15 and 40.

### DESCRIPTION OF THE FIGURES

FIG. 1 shows how data streams from the thermocouples was treated to extract the frequency of high temperature diesel particulate trap regeneration events.

FIGS. 2 and 3 shows a comparison between two light duty Euro 4 diesel engine test cycles, FIG. 2 representing the first 5000 miles of an oil drain interval, FIG. 3 representing the second 5000 miles of the oil drain interval. Data from two cars was averaged into a single data set.

### DETAILED DESCRIPTION OF THE INVENTION

The present invention relates to the use of a lubricant to lubricate a compression ignition internal combustion engine, i.e. a diesel engine and similar designed engine in which combustion is intermittent.

Applicants have found that the use of a lubricant comprising a Fischer-Tropsch derived base oil leads to a significant and unexpected reduction of the regeneration frequency of a particulate trap in a diesel engine equipped with a particulate trap. This results in a reduction in NOx emission as well as a reduction in fuel consumption. A suitable trap is a catalysed particulate trap which is a continuously regenerating trap comprising both an oxidation catalyst and a filter.

### DETAILED DESCRIPTION OF THE FIGURES

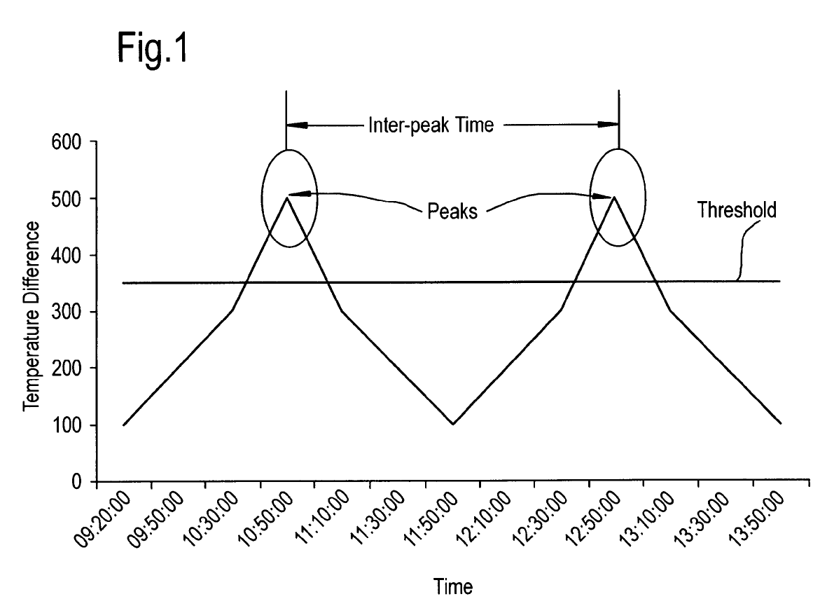

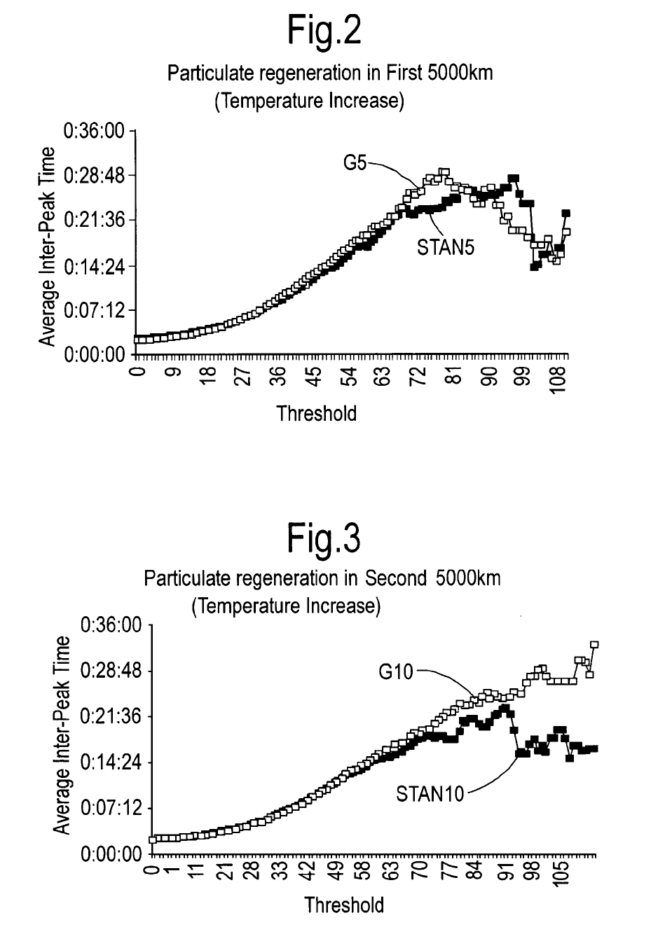

FIG. 1 shows how data was analysed, where temperature differentials were filtered using a threshold, so that only the highest differential temperature events are considered, since these are the thermal events associated with regeneration. In FIGS. 2 and 3, it can clearly be seen that as the threshold is raised, then there is divergence between the inter-peak differential temperature time for the two lubricant formulations. The Fischer-Tropsch based formulation had a consistently greater inter-peak time than did the standard mineral API Gp III base oil based formulation. FIGS. 2 and 3 shows a simple comparison of time in minutes and seconds, between peaks of differential temperature, as a function of the threshold. The threshold is the temperature increase above the threshold value.

Typically, a Diesel engine comprises a crankcase, cylinder head, and cylinders. The lubricant is typically present in the crankcase, where crankshaft, bearings, and bottoms of rods connecting pistons to the crankshaft are coated in the lubricant. The rapid motion of these parts causes the lubricant to splash and lubricate the contacting surfaces between the piston rings and interior surfaces of the cylinders. This lubricant film also serves as a seal between the piston rings and cylinder walls to separate the combustion volume in the cylinders from the space in the crankcase. The lubricant composition lubricates the diesel engine by forming a film between surfaces of parts moving against each other so as to minimize direct contact between them. This lubricating film decreases friction, wearing, and production of excessive heat between the moving parts. Further, the lubricant acts as cooling fluid by transposing heat from surfaces of lubricated parts which may be due to friction from parts moving against each other or the oil film, or derived from the actual combustion. The engine may be of the direct injection type, for example of the rotary pump, in-line pump, unit pump, electronic unit injector or common rail type, or of the indirect injection type. It may be a heavy or a light duty diesel engine.

The Diesel engine is equipped with a diesel particulate trap, such as a Continuously Regenerating Trap (CRT) as disclosed in EP-A-1108862, EP-A-1567622, and EP-A-1251248. Such traps are devices that remove diesel particulate matter or soot from the exhaust gas of a diesel engine by forcing the exhaust gas to flow through a filter comprised in the DPT. As the DPT's filter becomes saturated, the DPT usually is designed to regenerate by burning off the accumulated particulate matter. This may be done through a passive activation by the addition of a catalyst composition, such as organo-cerium compounds to the exhaust gases prior to the DPT or the DPT itself, or through an active regeneration technology. The latter involves heating the filter to soot combustion temperatures, either through increased exhaust gas temperatures, through a fuel injection, through a separate fuel burner, through an increased NO_{X}-exhaust gas concentration to oxidize the particulates at relatively low temperatures, or through similar methods. This process is known as “DPT regeneration”. Diesel particulate matter usually combusts at a temperature above 600° C. The start of combustion causes a further increase in temperature, which in turn may increase emissions of NO_{X} and CO. Independently from the specific approach taken, the active regeneration of DPT systems consumes additional fuel during the regeneration stage. Accordingly, it was found that a reduction in the regeneration frequency would be beneficial due to reduced energy consumption, as well as decreased overall average fuel exhaust gas temperatures, which results in a lower amounts of NO_{X} and CO produced.

The lubricant comprises at least one base oil having a paraffin content of greater than 80 wt % paraffins and a saturates content of greater than 98 wt % and comprising a continuous series of iso-paraffins having n, n+1, n+2, n+3 and n+4 carbon atoms. The base oil preferably is a Fischer-Tropsch derived base oil, having a paraffin content of greater than 80 wt % paraffins, a saturates content of greater than 98 wt % and comprises a continuous series of iso-paraffins having n, n+1, n+2, n+3 and n+4 carbon atoms, wherein n is between 15 and 40. The content and the presence of the a continuous series of the series of iso-paraffins having n, n+1, n+2, n+3 and n+4 carbon atoms in the base oil or base stock (i) may be measured by Field desorption/Field Ionisation (FD/FI) technique. In this technique the oil sample is first separated into a polar (aromatic) phase and a non-polar (saturates) phase by making use of a high performance liquid chromatography (HPLC) method IP368/01, wherein as mobile phase pentane is used instead of hexane as the method states. The saturates and aromatic fractions are then analyzed using a Finnigan MAT90 mass spectrometer equipped with a Field desorption/Field Ionisation (FD/FI) interface, wherein FI (a “soft” ionisation technique) is used for the determination of hydrocarbon types in terms of carbon number and hydrogen deficiency. The type classification of compounds in mass spectrometry is determined by the characteristic ions formed and is normally classified by “z number”. This is given by the general formula for all hydrocarbon species: CnH2n+z. Because the saturates phase is analysed separately from the aromatic phase it is possible to determine the content of the different iso-paraffins having the same stoichiometry or n-number. The results of the mass spectrometer are processed using commercial software (poly 32; available from Sierra Analytics LLC, 3453 Dragoo Park Drive, Modesto, Calif. GA 95350 USA) to determine the relative proportions of each hydrocarbon type.

The base oil may preferably be obtained by hydroisomerisation of a paraffinic Fischer-Tropsch derived wax, preferably followed by some type of dewaxing, such as catalytic dewaxing. By “obtained from a Fischer-Tropsch synthesis process”, or “Fischer-Tropsch derived” herein is meant that a fuel component or a base oil is, or derives from, a synthesis product of a Fischer-Tropsch condensation process. The term “non-Fischer-Tropsch derived” may be interpreted accordingly. A Fischer-Tropsch derived fuel may also be referred to as a GTL (Gas-To-Liquids) fuel.

A Fischer-Tropsch reaction converts carbon monoxide and hydrogen into longer chain, usually paraffinic, hydrocarbons:

n(CO+2H₂)=(—CH₂—)ₙ+nH₂O+heat.

This is performed in the presence of an appropriate catalyst and typically at elevated temperatures (e.g., 125 to 300° C., preferably 175 to 250° C.) and/or pressures (e.g., 5 to 100 bar, preferably 12 to 50 bar). Hydrogen to carbon monoxide ratios other than 2:1 may be employed if desired. The carbon monoxide and hydrogen may themselves be derived from organic or inorganic, natural or synthetic sources, typically either from natural gas or from organically derived methane, coal or biomass.

The base oils as derived from a Fischer-Tropsch wax as here described will be referred to in this description as Fischer-Tropsch derived base oils. Examples of Fischer-Tropsch processes which for example can be used to prepare the above-described Fischer-Tropsch derived base oil are the so-called commercial Slurry Phase Distillate technology of Sasol, the Shell Middle Distillate Synthesis Process and the “AGC-21” Exxon Mobil process. These and other processes are for example described in more detail in EP-A-776959, EP-A-668342, U.S. Pat. No. 4,943,672, U.S. Pat. No. 5,059,299, WO-A-9934917 and WO-A-9920720. Typically these Fischer-Tropsch synthesis products will comprise hydrocarbons having 1 to 100 and even more than 100 carbon atoms. This hydrocarbon product will comprise normal paraffins, iso-paraffins, oxygenated products and unsaturated products. If base oils are one of the desired iso-paraffinic products it may be advantageous to use a relatively heavy Fischer-Tropsch derived feed. The relatively heavy Fischer-Tropsch derived feed has at least 30 wt %, preferably at least 50 wt %, and more preferably at least 55 wt % of compounds having at least 30 carbon atoms. Furthermore the weight ratio of compounds having at least 60 or more carbon atoms and compounds having at least 30 carbon atoms of the Fischer-Tropsch derived feed is preferably at least 0.2, more preferably at least 0.4 and most preferably at least 0.55. Preferably the Fischer-Tropsch derived feed comprises a C₂₀⁺ fraction having an ASF-alpha value (Anderson-Schulz-Flory chain growth factor) of at least 0.925, preferably at least 0.935, more preferably at least 0.945, even more preferably at least 0.955. Such a Fischer-Tropsch derived feed can be obtained by any process, which yields a relatively heavy Fischer-Tropsch product as described above. Not all Fischer-Tropsch processes yield such a heavy product. An example of a suitable Fischer-Tropsch process is described in WO-A-9934917. The Fischer-Tropsch derived base oil will contain no or very little sulphur and nitrogen containing compounds. This is typical for a product derived from a Fischer-Tropsch reaction, which uses synthesis gas containing almost no impurities. Sulphur and nitrogen levels will generally be below the detection limits, which are currently 5 mg/kg for sulphur and 1 mg/kg for nitrogen respectively.

The process will generally comprise a Fischer-Tropsch synthesis, and at least one hydroisomerisation step. The hydroisomerisation steps are preferably comprises (a) hydrocracking/hydroisomerisating a Fischer-Tropsch product in the presence of a suitable catalyst, (b) separating the product of step (a) into at least one or more distillate fuel fractions and a base oil or base oil intermediate fraction.

If the viscosity and pour point of the base oil as obtained in step (b) is as desired no further processing is necessary and the oil can be used as the base oil according the invention. If desired, the pour point of the base oil intermediate fraction may suitably further reduced in a step (c) by means of solvent dewaxing, or preferably catalytic dewaxing of the oil obtained in step (b) to obtain a base oil having the preferred low pour point. The desired viscosity of the base oil may be obtained by isolating by means of distillation from the intermediate base oil fraction or from the dewaxed oil the suitable boiling range product corresponding with the desired viscosity. Distillation may be suitably a vacuum distillation step.

The hydroconversion/hydroisomerisation reaction of step (a) is preferably performed in the presence of hydrogen and a suitable catalyst. This catalyst may be chosen from those known to one skilled in the art pursuant its performance. The catalyst may in principle be any catalyst known in the art to be suitable for isomerising paraffinic molecules. In general, suitable hydroconversion/hydroisomerisation catalysts are those comprising a hydrogenation component supported on a refractory oxide carrier, such as amorphous silica-alumina (ASA), alumina, fluorided alumina, molecular sieves (zeolites) or mixtures of two or more of these. One type of preferred catalysts to be applied in the hydroconversion/hydroisomerisation step in accordance with the present invention are hydroconversion/hydroisomerisation catalysts comprising platinum and/or palladium as the hydrogenation component. A very much preferred hydroconversion/hydroisomerisation catalyst comprises platinum and palladium supported on an amorphous silica-alumina (ASA) carrier. The platinum and/or palladium is suitably present in an amount of from 0.1 to 5.0% by weight, more suitably from 0.2 to 2.0% by weight, calculated as element and based on total weight of carrier. If both present, the weight ratio of platinum to palladium may vary within wide limits, but suitably is in the range of from 0.05 to 10, more suitably 0.1 to 5. Examples of suitable noble metal on ASA catalysts are, for instance, disclosed in WO-A-9410264 and EP-A-0582347. Other suitable noble metal-based catalysts, such as platinum on a fluorided alumina carrier, are disclosed in e.g. U.S. Pat. No. 5,059,299 and WO-A-9220759.

A second type of suitable catalysts, described as non-noble metal hydroconversion/hydroisomerisation catalysts herein are those comprising at least one Group VIB metal, preferably tungsten and/or molybdenum, and at least one non-noble Group VIII metal, preferably nickel and/or cobalt, as the hydrogenation component. Both metals may be present as oxides, sulphides or a combination thereof. The Group VIB metal is suitably present in an amount of from 1 to 35% by weight, more suitably from 5 to 30% by weight, calculated as element and based on total weight of the carrier. The non-noble Group VIII metal is suitably present in an amount of from 1 to 25 wt %, preferably 2 to 15 wt %, calculated as element and based on total weight of carrier. Hydroconversion catalysts of this type found particularly suitable are catalysts comprising nickel and tungsten supported on fluorided alumina. The above non-noble metal-based catalysts are preferably used in their sulphided form. In order to maintain the sulphided form of the catalyst during use some sulphur needs to be present in the feed. Preferably at least 10 mg/kg and more preferably between 50 and 150 mg/kg of sulphur is present in the feed. An even further preferred catalyst that was found highly active in a non-sulphided form comprises a non-noble Group VIII metal, e.g., iron, nickel, in conjunction with a Group IB metal, e.g., copper, supported on an acidic support. Copper is preferably present to suppress hydrogenolysis of paraffins to methane. The catalyst has a pore volume preferably in the range of 0.35 to 1.10 ml/g as determined by water absorption, a surface area of preferably between 200-500 m²/g as determined by BET nitrogen adsorption, and a bulk density of between 0.4-1.0 g/ml. The catalyst support is preferably made of an amorphous silica-alumina wherein the alumina may be present within wide range of between 5 and 96 wt %, preferably between 20 and 85 wt %. The silica content as SiO₂ is preferably between 15 and 80 wt %. Also, the support may contain small amounts, e.g., 20-30 wt %, of a binder, e.g., alumina, silica, Group IVA metal oxides, and various types of clays, magnesia, etc., preferably alumina or silica. The preparation of amorphous silica-alumina microspheres has been described in Ryland, Lloyd B., Tamele, M. W., and Wilson, J. N., Cracking Catalysts, Catalysis: volume VII, Ed. Paul H. Emmett, Reinhold Publishing Corporation, New York, 1960, pp. 5-9.

The catalyst is prepared by co-impregnating the metals from solutions onto the support, drying at 100-150° C., and calcining in air at 200-550° C. The Group VIII metal is present in amounts of about 15 wt % or less, preferably 1-12 wt %, while the Group IB metal is usually present in lesser amounts, e.g., 1:2 to about 1:20 weight ratio respecting the Group VIII metal.

A typical catalyst is shown below:

| Ni, wt % | 2.5-3.5 | |
|---|---|---|
| Cu, wt % | 0.25-0.35 | |
| Al₂O₃—SiO₂ wt % | 65-75 | |
| Al₂O₃ (binder) wt % | 25-30 | |
| Surface Area | 290-325 | m²/g |
| Pore Volume (Hg) | 0.35-0.45 | ml/g |
| Bulk Density | 0.58-0.68 | g/ml |

Another class of suitable hydroconversion/hydroisomerisation catalysts are those based on molecular sieve type materials, suitably comprising at least one Group VIII metal component, preferably Pt and/or Pd, as the hydrogenation component. Suitable zeolitic and other aluminosilicate materials, then, include Zeolite beta, Zeolite Y, Ultra Stable Y, ZSM-5, ZSM-12, ZSM-22, ZSM-23, ZSM-48, MCM-68, ZSM-35, SSZ-32, ferrierite, mordenite and silica-aluminophosphates, such as SAPO-11 and SAPO-31. Examples of suitable hydroisomerisation/hydroisomerisation catalysts are, for instance, described in WO-A-9201657. Combinations of these catalysts are also possible. Very suitable hydroconversion/hydroisomerisation processes are those involving a first step wherein a zeolite beta or ZSM-48 based catalyst is used and a second step wherein a ZSM-5, ZSM-12, ZSM-22, ZSM-23, ZSM-48, MCM-68, ZSM-35, SSZ-32, ferrierite, mordenite based catalyst is used. Of the latter group ZSM-23, ZSM-22 and ZSM-48 are preferred. Examples of such processes are described in US-A-20040065581, which disclose a process comprising a first step catalyst comprising platinum and zeolite beta and a second step catalyst comprising platinum and ZSM-48. These processes are capable of yielding a base oil product which does not require a further dewaxing step.

Combinations wherein the Fischer-Tropsch product is first subjected to a first hydroisomerisation step using the amorphous catalyst comprising a silica-alumina carrier as described above followed by a second hydroisomerisation step using the catalyst comprising the molecular sieve has also been identified as a preferred process to prepare the base oil to be used in the present invention. More preferred the first and second hydroisomerisation steps are performed in series flow. Most preferred the two steps are performed in a single reactor comprising beds of the above amorphous and/or crystalline catalyst.

In step (a) the feed is contacted with hydrogen in the presence of the catalyst at elevated temperature and pressure. The temperatures typically will be in the range of from 175 to 380° C., preferably higher than 250° C. and more preferably from 300 to 370° C. The pressure will typically be in the range of from 10 to 250 bar and preferably between 20 and 80 bar. Hydrogen may be supplied at a gas hourly space velocity of from 100 to 10000 N1/l/hr, preferably from 500 to 5000 N1/l/hr. The hydrocarbon feed may be provided at a weight hourly space velocity of from 0.1 to 5 kg/l/hr, preferably higher than 0.5 kg/l/hr and more preferably lower than 2 kg/l/hr. The ratio of hydrogen to hydrocarbon feed may range from 100 to 5000 Nl/kg and is preferably from 250 to 2500 Nl/kg.

The conversion in step (a) is defined as the weight percentage of the feed boiling above 370° C. which reacts per pass to a fraction boiling below 370° C., is at least 20 wt %, preferably at least 25 wt %, but preferably not more than 80 wt %, more preferably not more than 65 wt %. The feed as used above in the definition is the total hydrocarbon feed fed to step (a), thus also any optional recycle of a high boiling fraction which may be obtained in step (b).

In step (b) the product of step (a) is preferably separated into one or more distillate fuels fractions and a base oil or base oil precursor fraction having the desired viscosity properties. If the pour point is not in the desired range the pour point of the base oil is further reduced by means of a dewaxing step (c), preferably by catalytic dewaxing. In such an embodiment it may be a further advantage to dewax a wider boiling fraction of the product of step (a). From the resulting dewaxed product the base oil and oils having a desired viscosity can then be advantageously isolated by means of distillation. Dewaxing is preferably performed by catalytic dewaxing as for example described in WO-A-02070629, which publication is hereby incorporated by reference. The final boiling point of the feed to the dewaxing step (c) may be the final boiling point of the product of step (a) or lower if desired.

The base oil component suitably has a kinematic viscosity at 100° C. of from 1 to 25 mm²/sec. Preferably, it has a kinematic viscosity at 100° C. of from 2 to 15 mm²/sec, more preferably of from 2,5 to 8,5 mm²/sec, yet more preferably from 2,75 to 5,5 mm²/sec.

Yet more preferably, it has a kinematic viscosity at 100° C. below 5,5 mm²/sec, more preferably below 4 mm²/sec, most preferably below 3 mm²/sec. Obviously, mixture of Fischer-Tropsch derived base oils may be employed as well. The pour point of the base oil is preferably below −30° C. The flash point of the base oil as measured by ASTM D92 preferably is greater than 120° C., more preferably even greater than 140° C.

The lubricant composition preferably has a viscosity index in the range of from 100 to 600, more preferably a viscosity index in the range of from 110 to 200, and even more preferably a viscosity index in the range of from 120 to 150.

The lubricant may comprise as the base oil component exclusively the paraffinic base oil, or a combination of the paraffinic base oils, or alternatively a combination of the paraffinic base oil one or more additional base oil components. The additional base oil component will suitably be present in an amount of less than 20 wt %, more preferably less than 10 wt %, again more preferably less than 5 wt % of the total fluid lubricant formulation. Examples of such base oils are mineral based paraffinic and naphthenic type base oils and synthetic base oils, for example poly alpha olefins, poly alkylene glycols, esters and the like.

Preferably, the lubricant further comprises saturated cyclic hydrocarbons in an amount of from 5 to 10% by weight, based on the total lubricant since this improves the low temperature compatibility of the different components in the lubricant.

The lubricant according to the invention further may preferably comprise a viscosity improver in an amount of from 0.01 to 30% by weight. Viscosity index improvers (also known as VI improvers, viscosity modifiers, or viscosity improvers) provide lubricants with high- and low-temperature operability. These additives impart acceptable viscosity at low temperatures and are preferably shear stable. The lubricant further preferably comprises at least one other additional lubricant component in effective amounts, such as for instance polar and/or non-polar lubricant base oils, and performance additives such as for example, but not limited to, metallic and ashless oxidation inhibitors, ashless dispersants, metallic and ashless detergents, corrosion and rust inhibitors, metal deactivators, metallic and non-metallic, low-ash, phosphorus-containing and non-phosphorus, sulphur-containing and non-sulphur-containing anti-wear agents, metallic and non-metallic, phosphorus-containing and non-phosphorus, sulphur-containing and non-sulphurous extreme pressure additives, anti-seizure agents, pour point depressants, wax modifiers, viscosity modifiers, seal compatibility agents, friction modifiers, lubricity agents, anti-staining agents, chromophoric agents, anti foaming agents, demulsifiers, and other usually employed additive packages. For a review of many commonly used additives, reference is made to D. Klamann in Lubricants and Related Products, Verlag Chemie, Deerfield Beach, Fla.; ISBN 0-89573-177-0, and to “Lubricant Additives” by M. W. Ranney, published by Noyes Data Corporation of Parkridge, N.J. (1973).

The fuel composition is suitable for compression ignition engines, i.e. it comprises one or more fuel components that by boiling range and other structure are suitable to act as fuel for compression ignition engines. The fuel composition thus has a cetane number of at least 40, a sulphur content of less than 100 ppm and a flash point of at least 68° C.

The components of the fuel preferably have boiling points within the typical diesel fuel (“gas oil”) range, i.e., from about 150 to 400° C. or from 170 to 370° C. It will suitably have a 90% w/w distillation temperature of from 300 to 370° C. The fuel composition will preferably be, overall, a low or ultra low sulphur fuel composition, or a sulphur free fuel composition, for instance containing at most 500 ppmw, preferably no more than 350 ppmw, most preferably no more than 100 or 50 ppmw, or even 10 ppmw or less, of sulphur.

Where the fuel composition is an automotive diesel fuel composition, it preferably falls within applicable current standard specification(s) such as for example EN 590:99. It suitably has a density from 0.82 to 0.845 g/cm³ at 15° C.; a final boiling point (ASTM D86) of 360° C. or less; a cetane number (ASTM D613) of 51 or greater; a kinematic viscosity (ASTM D445) from 2 to 4.5 centistokes at 40° C.; a sulphur content (ASTM D2622) of 350 ppmw or less; and/or a total aromatics content (IP 391 (mod)) of less than 11.

The fuel composition may comprise one or more fuel components, of which preferably at least one is a paraffinic gas oil component. The paraffinic gas oil component will typically have a density from 0.76 to 0.79 g/cm³ at 15° C.; a cetane number (ASTM D613) of at least 65, preferably greater than 70, suitably from 74 to 85; a kinematic viscosity (ASTM D445) from 2 to 4.5, preferably from 2.5 to 4.0, more preferably from 2.9 to 3.7, centistokes at 40° C.; and a sulphur content (ASTM D2622) of 5 ppmw or less, preferably of 2 ppmw or less.

The fuel composition preferably comprises at least 80% w/w, more preferably at least 90% w/w, most preferably at least 95% w/w, of paraffinic components, preferably iso- and linear paraffins. The weight ratio of iso-paraffins to normal paraffins will suitably be greater than 0.3 and may be up to 12; suitably it is from 2 to 6. Preferably, the fuel composition contains less than 10% by mass of aromatic compounds.

The paraffinic gas oil component is preferably obtained from a Fischer-Tropsch synthesis process, in particular from the product fraction boiling in the gas oil and/or kerosene range.

The fuel may itself be additivated (additive-containing) or unadditivated (additive-free). If additivated, it will contain one or more additives selected for example from anti-static agents, pipeline drag reducers, flow improvers (e.g. ethylene/vinyl acetate copolymers or acrylate/maleic anhydride copolymers), lubricity additives, antioxidants and wax anti-settling agents.

The present invention further relates to a process for operating a diesel engine equipped with a diesel particulate trap, comprising lubricating the diesel engine with a lubricating oil composition, wherein the lubricant composition comprises a base oil or base stock having a paraffin content of greater than 80 wt % paraffins and a saturates content of greater than 98 wt % and comprising (i) a series of iso-paraffins having n, n+1, n+2, n+3 and n+4 carbon atoms and wherein n is between 15 and 40.

This process has the advantage that the overall fuel consumption and the exhaust gas emissions are reduced, while at the same time the lifetime of the DPT components is increased. Furthermore, the high oxidative stability of the lubricant will allow increased periods of operation without affecting the quality of the lubricant, and hence reduced formation of oxidation products such as organic acids which lead to corrosion of the engine.

The invention will be further illustrated by the following, non-limiting example:

### Example 1

In an experiment using back-to-back tests, a pair of Euro 4 diesel engined Mercedes C-class passenger cars were run on equivalent 5W-40 engine crankcase lubricant formulations blended with either a GTL Base Oil (Oil A) or a mineral hydrowax based Gp III base oil (Oil B). Each car was run with lubricants in the order A-B-A or B-A-B to allow for car-to-car effects. The DPTs were monitored by pairs of thermocouples upstream and downstream of the DPTs.

The frequency of DPT re-generation was monitored via temperature differential spikes across the DPTs and as back pressure peaks in the exhaust system. The trap re-generation frequency was monitored continuously with a data-logger throughout a 10,000 mile oil drain interval (ODI).

### Fuel Compositions

Two automotive gas oil compositions were prepared: A Fischer-Tropsch automotive gas oil (F-T AGO) blend consisted of a base fuel (S040990) with 250 mg/kg R655 lubricity improver and STADIS 450 anti-static additive. The conventional automotive gas oil (mineral AGO) was a 50 ppm sulphur fuel meeting European EN590 specification. The fuel code was DK1703. The composition of the two fuels is depicted in Table 1:

TABLE 1

| | Test | | Comparative |
|---|---|---|---|
| Fuel property | method | F1 | F2 |
| Density @ 15° C. | IP | 0.7846 | 0.8326 |
| (g/cm³) | 365/ASTM | | |
| | D4052 | | |
| Distillation | IP | | |
| | 123/ASTM | | |
| | D86 | | |
| IBP (° C.) | | 219.5 | 169.0 |
| 10% | | 245.9 | 209.0 |
| 20% | | 258.8 | 231.0 |
| 30% | | 270.1 | 249.0 |
| 40% | | 282.5 | 262.5 |
| 50% | | 295.2 | 274.5 |
| 60% | | 307.2 | 285.5 |
| 70% | | 317.7 | 296.5 |
| 80% | | 328.1 | 309.0 |
| 90% | | 342.1 | 327.0 |
| 95% | | 353 | 342.0 |
| FBP | | 358.2 | 357.0 |
| Cetane number | ASTM D613 | 79 | 54.8 |
| Kinematic | IP 71/ASTM | 3.497 | 2.895 |
| viscosity @ 40° | D445 | | |
| C. (centistokes) | | | |
| (mm²/s) | | | |
| Cloud point (° C.) | DIN EN | −0.5 | −11 |
| | 23015 | | |
| Sulphur (WDXRF) | ASTM D2622 | <5 | 49 |
| (ppmw) | | | |

The gas oil fuel F1 had been obtained from a Fischer-Tropsch (SMDS) synthesis product via a two-stage hydroconversion process analogous to that described in EP-A-0583836. The comparative fuel was a conventional,

### Lubricants

Two lubricant formulations were employed. For purposes of this test, the base oils were Gp III base oils:

The two Fischer-Tropsch derived base oils (BO1 and BO2) are base oils obtained by catalytic dewaxing from a hydro-isomerised Fischer-Tropsch wax obtained from Shell MDS Malaysia, (Bintulu, Malaysia).

For comparison, two mineral-derived base oils (BO3 and BO4) derived from a hydrowax feedstock (a fuel hydrocracker bottom wax) slate were employed. These are commercially available as YuBase Gp III base oils from SK Corporation, Ulsan, Korea (YuBase is a trademark of the SK corporation). BO1 and BO2 as well as BO3 and BO4 were formulated into a lubricant with a commercially available additive package. The formulations are based on current commercial 5W-40 API-CH4 Low SAPS diesel engine oils, see Table 2. The Fischer-Tropsch blend was comparable with the YuBase blend in terms of the kinematic viscosity at 100° C. and a cold crank viscosity (VdCCS) at −30° C. Table 3 shows the properties of the formulations:

TABLE 2
5W-40 Diesel engine lubricant characteristics

| | | | Comparative |
|---|---|---|---|
| | | | mineral |
| | VK100 (cSt | F-T derived | derived |
| Component | or mm²/, IP71) | lubricant | lubricant |
| BO1 (FT) | 5 | 45.31 | |
| BO2 (FT) | 8 | 23.25 | |
| BO3 | 4 | | 48.36 |
| BO4 | 8 | | 17.2 |
| Additive | | 13.6 | 13.6 |
| package | | | |
| Viscosity | | 17.54 | 20.54 |
| Modifier | | | |
| concentrate | | | |
| Pour point | | 0.3 | 0.3 |
| depressant | | | |
| Anti foaming | | 10 ppm | 10 ppm |
| additive | | | |

TABLE 3
Lubricant properties

| | | | | Comparative |
|---|---|---|---|---|
| | | | | mineral |
| | | | F-T derived | derived |
| Properties | Unit | Method | lubricant | lubricant |
| VK100 | cSt | IP71 | 13.99 | 13.88 |
| VK40 | cSt | IP71 | 83.90 | 81.74 |
| Noack | % wt. | CEC L- | 8.1 | 11.4 |
| Volatility | | 40-A93 | | |
| loss | | | | |
| Dynamic | cP | ASTM | 6573 | 6148 |
| viscosity | | D-5293 | | |
| (Could | | | | |
| crank | | | | |
| at −30° C.) | | | | |

The lubricants and fuels compositions disclosed above were employed to lubricate and to operate, respectively, an automotive EURO 4 engine (Table 4):

TABLE 4
Engine specification and nominal performance data

| Model: | |
|---|---|
| Engine: | Mercedes 4-cylinder DI diesel with |
| | exhaust gas recirculation (EGR) |
| | and continuous particle trap using |
| | cordierite filters |
| Cylinders: | Four in-line |
| Bore/Stroke: | 88 × 88.3 mm |
| Capacity: | 2.148 litres |
| Maximum Power: | 120 hp (89.5 kW) at 4200 rpm |
| Maximum Torque: | 270 Nm (199.3 lbft) at 1,600 rpm |
| Transmission: | ZF 6-speed manual drive |

The frequency of the DPT regeneration was measured as follows:

### Frequency of the DPT Regeneration for Mercedes Euro 4 Light Duty Diesel Engine

The regeneration frequency of the diesel particulate trap (DPT) was monitored using two thermocouples, one mounted upstream and one mounted downstream of the diesel particulate trap. The temperatures of each thermocouple (K-type thermocouples) were logged using a Grant SQ800 data logger, as a function of time, every 20 seconds. An ignition signal was also fed into the data logger in order to act as a stop/start for the data recording. Data was down loaded from the data logger to a Micro Soft Excel spreadsheet for data processing. A regeneration event involves a significant temperature increase by fuel injection into the DPT to combust the organic deposits. The thermocouples allowed consistent monitoring of the highest temperature events in the DPT, when the cars were in motion. The differential temperature between the two thermocouples gave a more accurate indication of a regeneration event.

The resulting data is depicted in FIGS. 2 and 3, which clearly show FIGS. 2 and 3 clearly illustrate that that the re-generation frequency benefit for the GTL lubricant was especially manifest in the second 5000 miles of the ODI. This not only means that the trap remains in good condition for longer with the GTL-based lubricant but there should also be a marginal improvement in fuel consumption as a result of the lower fuel usage for the re-generation process. It was found that there was a directional benefit in terms of the condition of the diesel particulate trap when the car was running on the GTL based lubricant, as manifest through a lower regeneration frequency.

The total number of diesel particulate regenerations during the trial are shown in Table 5 below.

TABLE 5
Number of diesel particulate regenerations

| | |
|---|---|
| Standard mineral diesel | 150 |
| fuel with YuBase Lube | |
| Standard mineral diesel | 125 |
| fuel with GTL Lube | |
| GTL diesel with YuBase Lube | 147 |
| GTL diesel with GTL Lube | 131 |

1. A process to increase the efficiency of a regenerable diesel particulate trap in a diesel engine equipped with a regenerable diesel particulate trap, the process comprising lubricating the engine with a lubricant that comprises a base oil component having a paraffin content of greater than 80 wt % paraffins, a saturates content of greater than 98 wt %, and comprising a series of iso-paraffins having n, n+1, n+2, n+3 and n+4 carbon atoms, wherein n is between 15 and 40.

2. A process according to claim 1, wherein the base oil has a kinematic viscosity at 100° C. of from 3 to 25 mm²/s.

3. A process according to claim 1, wherein the lubricant composition has a kinematic viscosity at 100° C. of more than 5.0 mm²/s (cSt), a cold cranking simulated dynamic viscosity at −15° C. according to ASTM D 5293 of less than 9500 mPas (cP) and a mini rotary viscosity test value of less than 60000 mPas at −20° C. according to ASTM D 4684.

4. A process according to claim 1, wherein the lubricant comprises a Fischer-Tropsch derived fuel component.

5. A process according to claim 4, wherein the Fischer-Tropsch derived fuel component has an iso-paraffin to n-paraffin mass ratio that generally increases as paraffin carbon number increases from C8 to C18, and wherein the fuel comprises less than 0.05% m/m sulphur and less than 10% by mass aromatics.

6. A process for operating a diesel engine equipped with a diesel particulate trap, comprising lubricating the diesel engine with a lubricating oil composition, wherein the lubricant composition comprises a base oil or base stock having a paraffin content of greater than 80 wt % paraffins and a saturates content of greater than 98 wt % and comprising (i) a series of iso-paraffins having n, n+1, n+2, n+3 and n+4 carbon atoms and wherein n is between 15 and 40.

7. A process according to claim 6, wherein the base oil has a kinematic viscosity at 100° C. of from 3 to 25 mm²/s.

8. A process according to claim 6, wherein the lubricant composition has a kinematic viscosity at 100° C. of more than 5.0 mm²/s (cSt), a cold cranking simulated dynamic viscosity at −15° C. according to ASTM D 5293 of less than 9500 mPas (cP) and a mini rotary viscosity test value of less than 60000 mPas at −20° C. according to ASTM D 4684.
